(19) United States
(12) Patent Application Publication
(10) Pub. No.: US 2025/0220020 A1
(43) Pub. Date: Jul. 3, 2025

(54) Service Protection for Software Agents on Protected Workloads

(71) Applicant: Cisco Technology, Inc., San Jose, CA (US)

(72) Inventors: Alessandro Boch, Milpitas, CA (US); Hanlin He, San Jose, CA (US); Harold Jiang, Santa Clara, CA (US); Gabriel J. Fontenot, Sunset, LA (US); Anthony V. Nguyen, Pittsburg, CA (US)

(21) Appl. No.: 18/401,014

(22) Filed: Dec. 29, 2023

(51) Int. Cl. H04L 9/40

(52) U.S. Cl. CPC H04L 63/102; H04L 63/068; H04L 63/20

(57) ABSTRACT

Devices, systems, methods, and processes for facilitating a service protection for a plurality of agents deployed on a network. These agents can be managed by a workload protection solution and provide a variety of telemetry and other data. However, when deployed on external computing systems, these agents may often be subject to process commands received from the operating system such as “stop” commands. In order to facilitate continued monitoring and data tracking, embodiments herein can direct an agent to ignore message and service requests received from outside processes. This can avoid being turned off during an update or other benign process, but may also protect against malicious entities that may attempt to stop the tracking of the workload being monitored. When a service protection configuration is received by the agent, it may avoid responding to service requests until a disable command is sent from the originating workload protection system.

The present disclosure relates to networking. More particularly, the present disclosure relates to protecting software agents from various services while operating within a workload protection solution.

### BACKGROUND

Software applications have become critically important for organizations worldwide, serving as the lifeblood of their operations. Applications not only drive revenue but also engage customers, facilitate business outcomes, and differentiate organizations from their competitors. Developers, as the creators of these applications, play a central role in business transformation and are valued customers of enterprise information technology (IT). IT operators, including networking professionals, provide business value by supporting applications with agility and efficiency.

Developers are deploying applications in multiple public and private clouds, often alongside legacy applications in various data centers. The rise of microservices is also contributing to the development of highly distributed application environments, with application tiers and data services spread across data centers and public clouds. However, outdated protocols and tools have failed to keep up with these dynamic application environments, leading to challenges in monitoring and ensuring application availability and performance.

Addressing these challenges can lead to better network performance and reliability. In response, workload protection solutions offer machine learning capabilities that provide actionable insights into network performance. They can enhance network visibility, supports mission-critical applications in both on-premises data centers and the public cloud, and offers comprehensive traffic telemetry information. The platform performs advanced analytics and tracks network topology, making it easier for operations teams to manage and optimize network performance for digital business and cloud infrastructures. Such a holistic approach to protect data centers and workloads across multiple cloud environments can be achieved, in part, by implementing segmentation, zero-trust models, and automated compliance enforcement.

However, it is often the case that software agents are installed and running on external workloads that are associated with an operating system. These external workloads may be owned and driven by a team of different network administrators. As a result, these agents are at risk for being turned off, disabled, or otherwise uninstalled by those network administrators. Additionally, malicious actors may also attempt to disable the agent while attempting to gain access to the workload.

### SUMMARY OF THE DISCLOSURE

Systems and methods for protecting software agents from various services while operating within a workload protection solution in accordance with embodiments of the disclosure are described herein. In some embodiments, a device includes a processor, at least one network interface controller configured to provide access to a network, and a memory communicatively coupled to the processor, wherein the memory includes a workload protection logic. The logic is configured to establish communication with one or more agents, apply a service protection configuration to the one or more agents, determine that an agent of the one or more agents should disable the service protection configuration, and transmit a disable command to the agent of the one or more agents.

In some embodiments, the workload protection logic is further configured to determine if at least one of the one or more agents should have an updated protection configuration, and transmit an updated protection configuration to the at least one of the one or more agents.

In some embodiments, a device includes a processor, at least one network interface controller configured to provide access to a workload protection logic. The device may further comprise a memory communicatively coupled to the processor, wherein the memory includes an agent logic. The agent logic is configured to establish communication with the workload protection logic, receive a service protection configuration, enable service protection, notify an operating system associated with the device of the service protection configuration, receive a disable command, and determine if the disable command was received from the workload protection logic.

In some embodiments, the device, in response to the determination that the disable command was received from the workload protection logic, disable the service protection.

In some embodiments, the device, in response to the determination that the disable command was not received from the workload protection logic, ignores disable command.

In some embodiments, the agent logic is further configured to receive a configuration update command, and determine if the configuration update command was received from the workload protection logic.

In some embodiments, the device, in response to the determination that the configuration update command was received from the workload protection logic, update one or more configurations associated with the configuration update command.

In some embodiments, the device, in response to the determination that the configuration update command was not received from the workload protection logic, the configuration update command is ignored.

In some embodiments, the agent logic is configured to receive commands from a backdoor command line execution process.

In some embodiments, the agent logic is further configured to determine if the disable command was received from the backdoor command line execution process.

In some embodiments, the agent logic, in response to the determination that the disable command was received from the backdoor command line execution process, disable the service protection.

In some embodiments, the device, in response to the determination that the disable command was not received from the workload protection logic or the backdoor command line execution process, ignores the disable command.

In some embodiments, the agent logic is further configured to receive a service request.

In some embodiments, a notification to the operating system includes at least a notification that no service requests will be accepted until the service protection configuration is disabled.

In some embodiments, the agent logic is further configured to determine if the service protection configuration is enabled, and in response to the protection configuration being enabled, ignore the service request.

In some embodiments, a method of operating an agent includes establishing communication with a workload protection logic, receiving a service protection configuration, enabling service protection, notifying an operating system associated with a device of the service protection configuration, receiving a command with a time-based one-time password (TOTP), verify the TOTP is valid, and executing, in response to the TOTP being verified as valid, the command.

In some embodiments, the command is received from a command line execution process.

In some embodiments, the command is received from a workload protection logic.

In some embodiments, the command is a configuration update command.

In some embodiments, the command is a disable command.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that a workload protection logic may operate within in accordance with various embodiments of the disclosure;

FIG. 2 is a conceptual illustration of a segmentation model within a workload protection system in accordance with various embodiments of the disclosure;

FIG. 3 is a conceptual hierarchal scope design within a workload protection system in accordance with various embodiments of the disclosure;

FIG. 4 is a conceptual illustration of a network topology operating with a workload protection system in accordance with various embodiments of the disclosure;

FIG. 5 is a conceptual illustration of an agent operating within an environment in accordance with various embodiments of the disclosure;

FIG. 6 is a flowchart depicting a process for engaging a service protection configuration with an agent in accordance with various embodiments of the disclosure;

FIG. 7 is a flowchart depicting a process for managing an agent with a received service protection configuration in accordance with various embodiments of the disclosure;

FIG. 8 is a flowchart depicting a process for managing an agent with a received service request in accordance with various embodiments of the disclosure;

FIG. 9 is a flowchart depicting a process for engaging a service protection configuration with an agent capable of utilizing a time-based one-time password in accordance with various embodiments of the disclosure;

FIG. 10 is a flowchart depicting a process for managing an agent with a received service protection configuration capable of utilizing a time-based one-time password in accordance with various embodiments of the disclosure; and

FIG. 11 is a conceptual block diagram of a device suitable for configuration with a workload protection logic and/or an agent logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can facilitate service protection within agents operated by a workload protection solution. In many embodiments, the network administrator of the workload protection solution can enable a service protection configuration from a product console. This workload protection solution can be configured to transmit out to all relevant agents. This transmission can be done via a protected communication channel (such as a transport layer security channel) between the agent and the workload protection solution logic.

Agents, upon receiving the service protection configuration, can interact with the host operating system (such as through a service application programming interface) and inform the operating system that the agent's service will not accept the request to stop. Thus, the uninstallation of that agent is now indirectly blocked by the same configuration. For example, an Microsoft Windows installer (MSI) will not be able to proceed if it cannot turn the service off.

The agent's service configuration properties can also be protected and can be configured to not be changed on the system. The service startup type and recovery options may also be set to not be modified, thus preventing the service from being disabled. This can also prevent an agent service from being deleted.

Disabling service protection can be done in multiple ways. In some embodiments, the service protection configuration can be disabled in a similar way as the engagement of the configuration, via a direct communication from the workload protection logic, often through a product console operating by a network administrator. In additional embodiments, the service protection configuration can be bypassed or disabled locally on the agent by utilizing a time-based one-time password (TOTP). This TOTP can be generated on the backed, and is useful when the agent cannot communicate with the backend configuration server or other workload protection logic.

In further embodiments, the service protection configuration can be disabled via the product console through the workload protection logic. The agent may internally generate a TOTP and send a request to the agent manager to disable the service protection. The agent manager will successfully validate the TOTP and inform the OS that it will accept certain signals, such as a stop signal. This may also be timed for certain operations such as agent upgrades, etc.

In more embodiments, the protection at the workload may be bypassed by a network administrator. A TOTP can be generated via the product console available through the workload protection logic and can be passed to the running agent via the existing operating system infrastructure. The agent's binary can be utilized as a command line command with a dedicated option to disable the service protection. In these embodiments, the option can have a parameter be the TOTP. Upon receiving the command with the TOTP token, the agent manager can compute the current valid token based on various factors. In certain embodiments, the current valid token can be based on the machine's time, a secret, and the agent's identifier, which can be provided upon the agent registration with the workload protection logic, etc. The computed token can be compared with the received token. If they match, the agent can inform the operating system that it will again accept certain signals, including a stop signal. These tokens can change validation every period of time. In some embodiments, this period of time may be fifteen minutes.

In various embodiments, there can be three valid TOTPs: one specific to an agent (based on the agent's identifier for example), one specific to all of the agents in a tenant (based on a tenant key for example), and one valid for all the agents connected to the backed (based on the backend public certificate). In many embodiments, the backend can be the workload protection logic or other related device. In more embodiments, all three items necessary for each specific TOTP can be known to an agent and to the workload protection logic. The secret can be hardcoded into the workload protection logic and into the agent logic.

In response to receiving a “disable service protection” request, the agent can compute all three TOTPs, and compare the associated TOTP with each of the three. If a TOTP does not match, then the requests will become throttled, which can help prevent a malicious actor from brute forcing TOTPs. The workload protection logic can provide an API, such as a RESTful API that can be utilized for retrieving the three kinds of TOTPs. Authorization to access the API can be limited to the network administrator.

### Workload Protection Solutions

In many embodiments, a workload protection solution offers a holistic approach to protect data centers across multiple cloud environments by implementing a zero-trust model through segmentation. This approach helps in faster detection of security incidents, containment of lateral movement, and reduction of the attack surface. Workload protection solutions are often infrastructure-agnostic and support on-premises as well as public cloud workloads. These solutions can provide capabilities like automated “allow list” policy generation based on real-time telemetry data, enforcing a zero-trust model, identifying process behavior deviations, and detecting software vulnerabilities. These workload protection solutions can be deployed in numerous way including, but not limited to, appliance-based, virtual, and Software as a Service (“SaaS”) deployment solutions.

### Workloads

In the context of various network infrastructures, a “workload” typically refers to a unit of work or a specific set of tasks that a computing system, server, or other network device is responsible for executing. In some environments, the term “workload” may be hosts that have a Secure Workload Agent (“SWA”) installed while hosts that do not have a SWA installed on them can be considered “IP addresses”.

Workloads can vary widely and encompass various types of applications and services, including application workloads like web applications and databases, virtualization workloads represented by virtual machines or containers in virtualized environments, data workloads related to data processing and storage tasks, network workloads associated with network services and data transmission, security workloads for services like firewalls and encryption, and storage workloads concerning data storage and management. Workload protection solutions can secure these various workloads in data centers, cloud environments, and network infrastructures. Understanding and efficiently securing various workloads is often considered essential for optimizing resource utilization and ensuring the performance, and reliability of IT systems.

### Segmentation

In networking, “segmentation” often refers to the strategic practice of dividing a network into smaller, isolated segments or subnetworks. Workload protection solutions can utilize segmentation to achieve several critical objectives. Firstly, it bolsters network security by isolating different segments from one another, safeguarding against the potential fallout of a security breach in one segment from affecting the entire network. These segmentation solutions can enforce security policies and regulate traffic flow between segments to prevent unauthorized access and data breaches.

Secondly, segmentation can often simplify network management. By breaking down a large network into more manageable parts, administrators can apply specific policies, monitor network traffic, and troubleshoot issues more effectively within each isolated segment. Additionally, network performance can benefit from segmentation as it reduces congestion and contention for network resources, ultimately enhancing the performance of critical applications and services. Workload protection solutions can be configured to implement network segmentation and micro-segmentation. These tools empower organizations to create, manage, and maintain network segments efficiently, contributing to a more secure, manageable, and streamlined network infrastructure.

### Zero-Trust

Also, in the realm of networking, “zero-trust” typically represents a security paradigm that fundamentally challenges the traditional notion of trust within network environments. This model can operate on the premise that no entity, whether situated inside or outside the network, should be automatically trusted. Instead, it mandates stringent access controls and continuous validation procedures. Entities, including users, devices, and applications, are required to authenticate their identity and demonstrate their security posture before being granted access to network resources. This approach aims to fortify network security by eliminating assumptions of trust and significantly reducing the risk of unauthorized access or breaches.

Zero trust principles encompass several key tenets. Firstly, identity verification is a prerequisite for access, necessitating robust authentication methods like multi-factor authentication (“MFA”). Secondly, access rights are strictly governed by the principle of least privilege, limiting permissions to the bare minimum essential for entities to perform their designated functions. Micro-segmentation can be employed to isolate and secure network segments, ensuring rigorous controls on traffic flow and minimizing the potential attack surface. Continuous monitoring of network traffic and entity behavior is paramount to promptly detect and respond to anomalies or security threats.

Lastly, encryption is often widely adopted to safeguard data, whether in transit or at rest. This comprehensive zero trust model can address the evolving threat landscape, acknowledging the presence of potential threats both within and outside the network. It is designed to enhance data and resource security, regardless of their location, in recognition that traditional perimeter-based security approaches are no longer adequate in today's complex and dynamic network environments. Workload protection solutions can be configured to provide solutions to implement a zero-trust security model effectively.

### Scopes

Scopes serve as a fundamental component in configuring and establishing policies within a workload protection solution. Scopes can be considered as collections of workloads organized in a hierarchical structure. Workloads can be labeled with attributes that provide insights into their location, role, and/or function in the environment. Often, the purpose of scopes is to offer a framework for dynamic mechanisms, particularly in terms of identification and attributes associated with changing IP addresses.

Scopes may also be primarily utilized for grouping datacenter applications and, when combined with roles, they enable precise control over the management of these applications. For instance, scopes play a pivotal role in defining access to policies, flows, and filters throughout the product. These scopes can be structured hierarchically, forming sets of trees with the root representing, for example, a Virtual Routing and Forwarding (VRF). Each scope tree hierarchy can represent distinct data that does not overlap with others. When defining individual scopes, key attributes can include the parent scope, name (for identification), type (for specifying different categories of inventory), and a query (that can define the individual scope). Often, it may be desired to organize one or more scopes hierarchically to mirror the application ownership hierarchy within the organization.

These scopes are often instrumental in constructing a hierarchical map of your network, which can be referred to as a “scope tree.” This hierarchical representation is essential for efficiently establishing and maintaining network policies. For example, utilizing a scope tree can enable the creation of a policy that can be automatically applied to every workload within a specific branch of that tree. Additionally, a scope tree can facilitate the delegation of responsibility for managing certain applications or network segments to individuals with the necessary expertise to define the appropriate policies for those workloads.

### Labels

Labels can play a crucial role in defining logical policies within a managed network. By way of non-limiting example, labels can be configured to enable the creation of policies like “allow traffic from “consumer network applications” to “provider database”.” Rather than specifying the exact members of the consumer and provider workload groups, these logical policies can be formulated using labels, providing flexibility in dynamically modifying the membership of these groups without altering the policy. Workload protection solutions can receive notifications from configured services, such as external orchestrators and cloud connectors, when workloads are added or removed. This may allow the workload protection solution to continually assess the composition of groups like “consumer network applications” and “provider database” to ensure accurate policy enforcement. Additionally, subnet-based label inheritance is supported, which can allow smaller subnets and IP addresses to inherit labels from larger subnets they belong to. This inheritance can occur when labels are either missing from the smaller subnet/address or when the label value for the smaller subnet/address is empty, enhancing the efficiency and consistency of label management.

### Agents

As those skilled in the art will recognize, a software agent or “agent” typically refers to a specialized and autonomous program or script that is designed to perform tasks or make decisions on behalf of a user, system, or organization. These agents can range from simple to highly complex and are often used to automate tasks, gather, and analyze data, and/or interact with other software systems and users. They can act on predefined rules and logic or adapt and learn from their environment. Software agents are used in various applications, including network management, artificial intelligence, data mining, and automation of routine tasks. They can be configured to allow software components to act independently or collaboratively to achieve specific goals.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

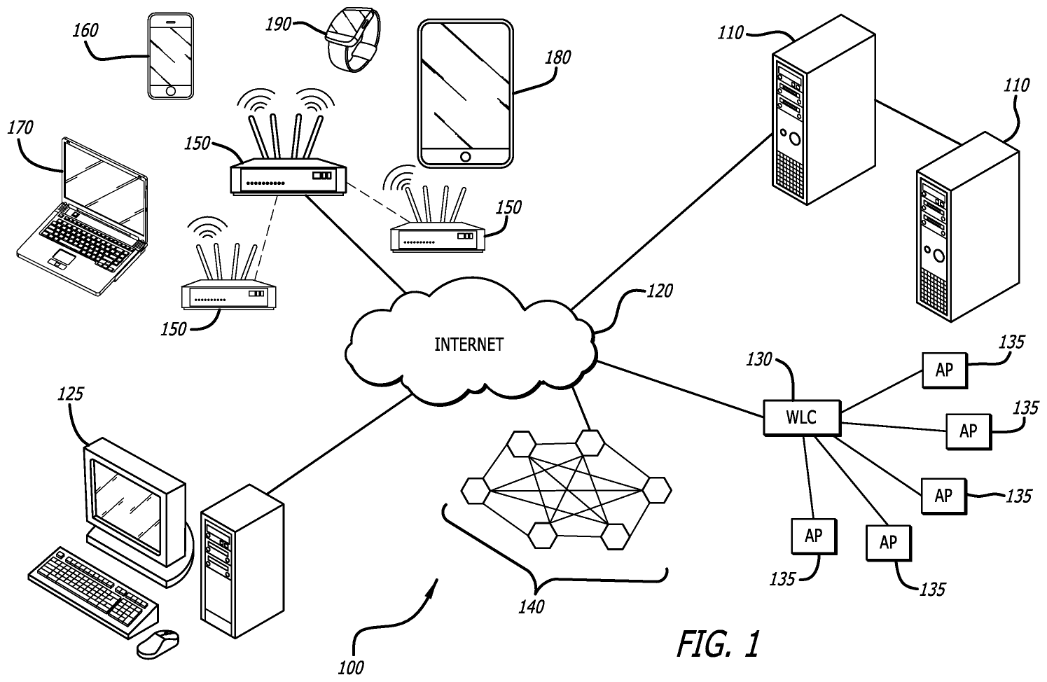

Referring to FIG. 1, a conceptual network diagram of various environments that a workload protection logic may operate within in accordance with various embodiments of the disclosure is shown. Those skilled in the art will recognize that a workload protection logic can be comprised of various hardware and/or software deployments and can be configured in a variety of ways. In some non-limiting examples, the workload protection logic can be configured as a standalone device, exist as a logic within another network device, be distributed among various network devices operating in tandem, or remotely operated as part of a cloud-based network management tool.

In many embodiments, the network 100 may comprise a plurality of devices that are configured to transmit and receive data for a plurality of clients. In various embodiments, cloud-based centralized management servers 110 are connected to a wide-area network such as, for example, the Internet 120. In further embodiments, cloud-based centralized management servers 110 can be configured with or otherwise operate a workload protection logic. The workload protection logic can be provided as a cloud-based service that can service remote networks, such as, but not limited to the deployed network 140. In these embodiments, the workload protection logic can be a logic that receives data from the deployed network 140 and generates predictions, receives environmental sensor signal data, and perhaps automates certain decisions or protective actions associated with the network devices. In certain embodiments, the workload protection logic can generate historical and/or algorithmic data in various embodiments and transmit that back to one or more network devices within the deployed network 140.

However, in additional embodiments, the workload protection logic may be operated as distributed logic across multiple network devices. In the embodiment depicted in FIG. 1, a plurality of network access points (APs) 150 can operate as a workload protection logic in a distributed manner or may have one specific device facilitate the detection of movement for the various APs. This can be done to provide sufficient needs to the network of APs such that, for example, a minimum bandwidth capacity may be available to various devices. These devices may include but are not limited to mobile computing devices including laptop computers 170, cellular phones 160, portable tablet computers 180 and wearable computing devices 190.

In still further embodiments, the workload protection logic may be integrated within another network device. In the embodiment depicted in FIG. 1, the wireless LAN controller 130 may have an integrated workload protection logic that it can use to generate predictions, and perhaps detect anomalous movements regarding the various APs 135 that it is connected to, either wired or wirelessly. In this way, the APs 135 can be configured such that they can read and report various signal levels and environmental sensor signals to the WLC 130. In still more embodiments, a personal computer 115 may be utilized to access and/or manage various aspects of the workload protection logic, either remotely or within the network itself. In the embodiment depicted in FIG. 1, the personal computer 115 communicates over the Internet 120 and can access the workload protection logic within the cloud based centralized management servers 110, the network APs 150, or the WLC 130 to modify or otherwise monitor the workload protection logic.

Although a specific embodiment for a conceptual network diagram of a various environments that a workload protection logic operating on a plurality of network devices suitable for carrying out the various steps, processes, methods, and operations described herein is discussed with respect to FIG. 1, any of a variety of systems and/or processes may be utilized in accordance with embodiments of the disclosure. For example, the workload protection logic may be implemented across a variety of the systems described herein such that some detections are generated on a first system type (e.g., remotely), while additional detection steps or protection actions are generated or determined in a second system type (e.g., locally). The elements depicted in FIG. 1 may also be interchangeable with other elements of FIGS. 1-2, and 4-11 as required to realize a particularly desired embodiment.

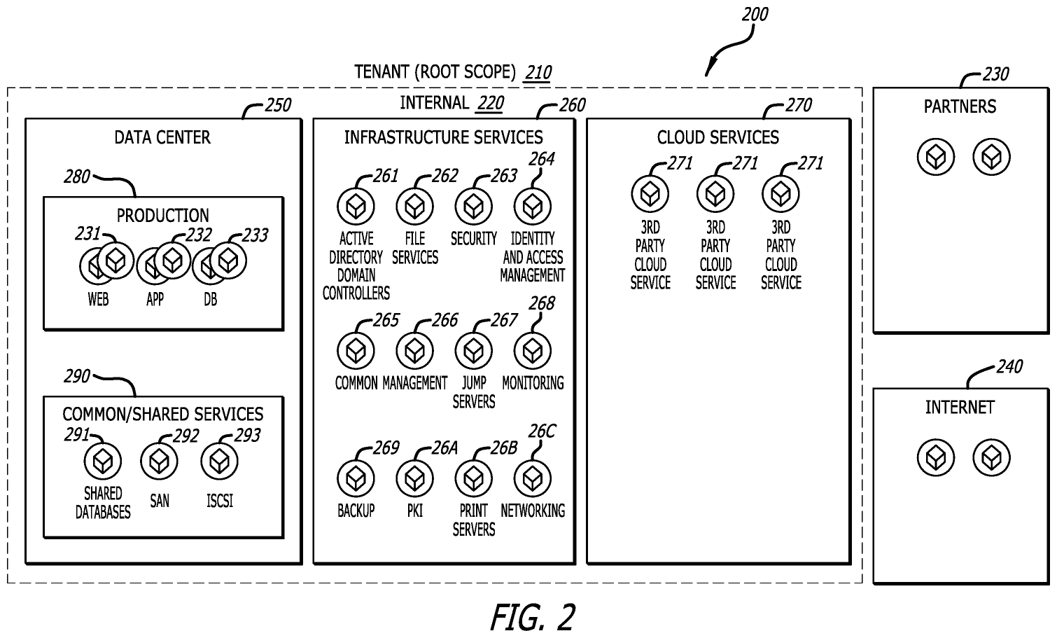

Referring to FIG. 2, a conceptual illustration of a segmentation model within a workload protection system in accordance with various embodiments of the disclosure is shown. As discussed above, segmentation can be utilized as a strategic dividing of a network into smaller, isolated segments or sub-networks. This segmentation can be applied to networks of various sizes and configurations. The embodiment depicted in FIG. 2 is a network 200 that is segmented into various segments.

In many embodiments, the network 200 can have a tenant or root scope 210 that encompasses all other segments. Within the root scope 210, an internal scope 220 and various external scopes can be segmented. In the embodiment depicted in FIG. 2, the external scopes include a partner segment 230 and an Internet segment 240. As discussed in more detail below, the external scopes and/or segments can include various services and databases.

In a number of embodiments, the internal scope 220 can include a number of segments. In the embodiment depicted in FIG. 2, the internal scope 220 includes a data center segment 250, an infrastructure services segment 260, and a cloud services segment 270. The data center segment 250 can itself comprise a production segment 280 and a common/shared services segment 290.

In some embodiments, the infrastructure services can include a plurality of segments. The embodiment depicted in FIG. 2 includes various segments such as an active directory domain controller segment 261, a file services segment 262, a security segment 263, an identity and access management segment 264, a common segment 265, a management segment 266, a jump services segment 267, a monitoring segment 268, a backup segment 269, a PKI segment 26A, a print servers segment 26B, and a networking segment 26C. As those skilled in the art will recognize, the number, amount, variety, and size of the segments in a scope can vary depending on the application desired.

Similarly, in various embodiments, the cloud services segment 270 can include a plurality of various third-party cloud services 271. Those skilled in the art will recognize that different cloud-based services can be incorporated based on the specific need. Likewise, additional embodiments may include a production segment 280 comprising a web segment 281, an app segment 282, and a database segment 283 (shown “DB”). In still more embodiments, a common/shared services segment 290 may comprise a shared databases segment 291, a SAN segment 292, and an ISCSI segment 293. Each of these segments can provide an additional layer of security and overall workload protection within a network.

Although a specific embodiment for a conceptual illustration of a segmentation model within a workload protection system suitable for carrying out the various steps, processes, methods, and operations described herein is discussed with respect to FIG. 2, any of a variety of systems and/or processes may be utilized in accordance with embodiments of the disclosure. For example, the segmentation can comprise more or fewer scopes as needed based on the desired application and each various devices associated with a particular segment may be redeployed to a new scope as needed. The scopes may be dynamically assigned. The elements depicted in FIG. 2 may also be interchangeable with other elements of FIGS. 1 and 3-11 as required to realize a particularly desired embodiment.

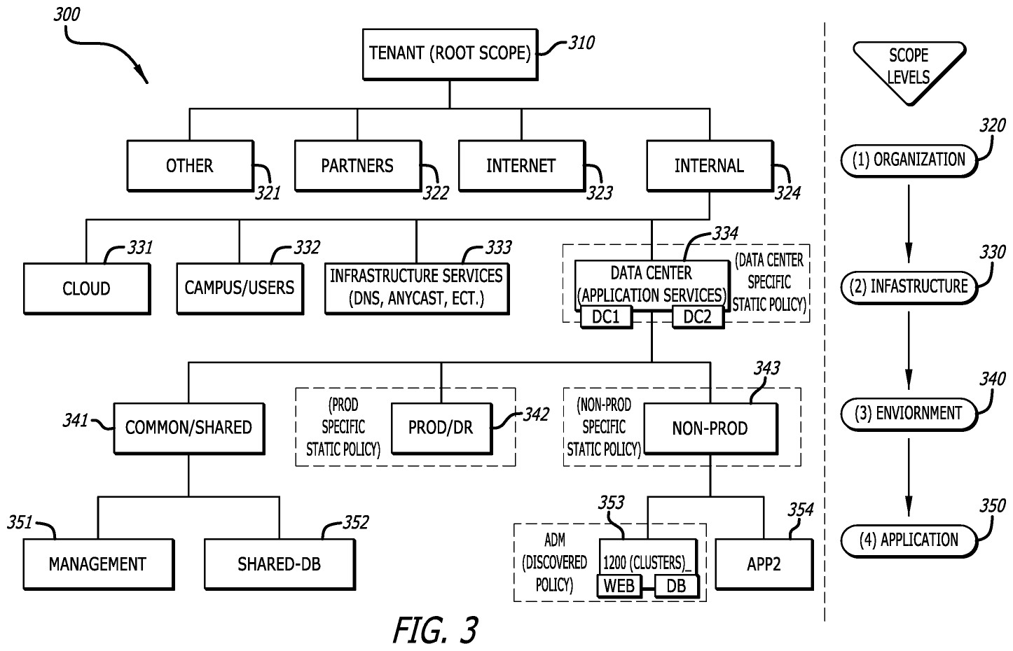

Referring to FIG. 3, a conceptual hierarchal scope design 300 within a workload protection system in accordance with various embodiments of the disclosure is shown. As discussed above, scopes can be configured as a collection of workloads that are organized in a hierarchal fashion. The embodiment depicted in FIG. 3 is a hierarchal scope design 300 that has an organization scope level 320, an infrastructure scope level 330, an environment scope level 340, and an application scope level 350. Each of these scope levels can be associated with a plurality of segments, applications, workloads, etc. Typically, however, each scope is nested within a tenant or root scope 310.

In the organization scope level 320, the embodiment depicted in FIG. 3 comprises an “other” segment 321, a partners segment 322, an Internet segment 323, and an internal segment 324. Each of these segments 321-324 is a child of the root scope 310. In some embodiments, the internal segment 324 can comprise a plurality of children segments that are associated with a different scope level. In the embodiment depicted in FIG. 3, the internal segment 324 has multiple children segments 331-334 that are associated with the infrastructure scope level 330. These children segments include a cloud segment 331 which can be associated with a plurality of third-party cloud-based services, a campus/users segment 332, an infrastructure services segment 323 (which is shown as including services such as, but not limited to, dynamic naming service, Anycast, and the like). The infrastructure scope level 330 may also include a data center segment 334 that can have a specific scope policy that is associated with one or more data centers such as a first data center (shown as “DC1”) and a second data center (shown as “DC2”) in the embodiment depicted in FIG. 3.

In further embodiments, an environment scope level 340 can be associated with a plurality of segments. In the embodiment depicted in FIG. 3, a common/shared segment 341, a production/DR segment 342, and a non-production segment 343 (shown as “Non-Prod”) is associated with the environment scope level 340. Both the production/DR segment 342, and the non-production segment 343 can have a specific status policy associated with each of them. Each of these segments 341-343 is depicted as being a child parent of the data center segment 334.

In more embodiments, the application scope level 350 can be associated with segments that are children of segments within the environment scope level 340. In the embodiment depicted in FIG. 3, the common/shared segment 341 has two children segments as a management segment 351 and a shared database segment 352 (shown as “Shared-DB”). Likewise, the nonproduction segment 343 can have two children segments in a cluster segment 353 (shown as “1200 (clusters) . . . ), and a second application scope 354 (shown as “APP2”). Furthermore, within the cluster segment 353, specific web or database services (shown as “DB”) can be associated with the segment that has an application dependency map applied as a discovered policy (shown as “ADM”). This hierarchal nature can aid a network or system administrator to visualize and understand relationships between various segments, allowing for more efficient application of network policies, providing increased network security.

Although a specific embodiment for a conceptual hierarchal scope design within a workload protection system suitable for carrying out the various steps, processes, methods, and operations described herein is discussed with respect to FIG. 3, any of a variety of systems and/or processes may be utilized in accordance with embodiments of the disclosure. For example, scope may vary depending on the size of the network or the application desired. Additionally, the scope may change based on one or more events or user input. The elements depicted in FIG. 3 may also be interchangeable with other elements of FIGS. 1-2 and 4-11 as required to realize a particularly desired embodiment.

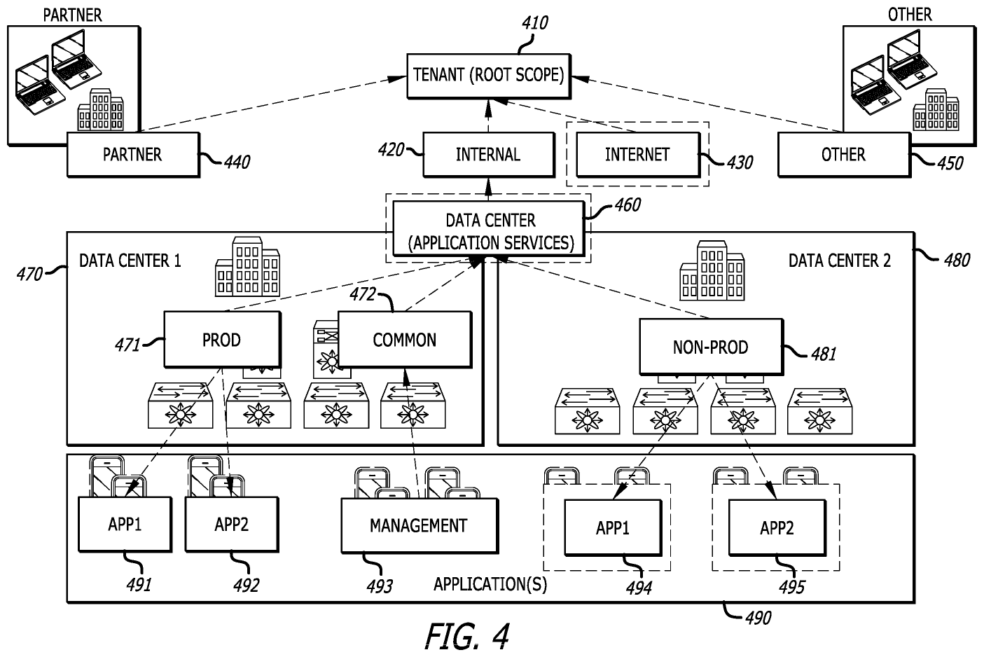

Referring to FIG. 4, a conceptual illustration of a network topology 400 operating with a workload protection system in accordance with various embodiments of the disclosure is shown. In many embodiments, the network topology 400 can include a tenant or root scope 410 which is connected to both a partner segment 440 and other segment 450 which can be external network segments. Conversely, the topology 400 can include an internal segment 420 and an Internet segment 430 that are also connected to the root scope 410.

In various embodiments, a data center segment 460 can include a plurality of data center segments. In the embodiment depicted in FIG. 4, there is a first data center segment 470 (shown as “data center 1”) and a second data center segment 480 (shown as “data center 2”). The first data center segment 470 can include a production segment 471 (shown as “PROD”) and a common segment 472. Each of these segments are children of the data center segment 460. Similarly, the second data center segment 480 can include a non-production segment 481 (shown as “Non-PROD”), which is also a child of the parent data center segment 460. As those skilled in the art will recognize, the number of segments and/or data centers that can be including within a topology 400 can vary based on the desired application or deployment.

In more embodiments, the topology 400 can include an application segment 490 that can include various sub-segments. In the embodiment depicted in FIG. 4, the application segment 490 includes a first application segment 491 (shown as “APP1”) and a second application segment 492 (shown as “APP2”) as well as a management segment 493. Each of these segments 491-493 are children of the first data center segment 470. Specifically, the first application segment 491 and second application segment 492 are children of the parent production segment 471, while the management segment 493 is a child of the parent common segment 472. Similarly, an additional series of non-production applications can be within the application segment 490. In the embodiment depicted in FIG. 4, a third application 494 (shown as “APP3”) and a fourth application 495 (shown as “APP4”).

Each of these segments, as shown in the topology 400 can allow for unique policy applications that can keep the overall network more secure. As those skilled in the art will recognize, the embodiments depicted in FIGS. 2-4 are all various ways to organize, visualize, or otherwise establish a segmentation strategy for a network. Each method of laying out a segmentation strategy can provide different views or aspects that can help address any issues or remaining portions of the network that still require segmentation or securing.

Although a specific embodiment for a conceptual illustration of a network topology operating with a workload protection system suitable for carrying out the various steps, processes, methods, and operations described herein is discussed with respect to FIG. 4, any of a variety of systems and/or processes may be utilized in accordance with embodiments of the disclosure. For example, specific layout of the topology 400 can vary greatly depending on the specific network being protected. The elements depicted in FIG. 4 may also be interchangeable with other elements of FIGS. 1-3 and 5-11 as required to realize a particularly desired embodiment.

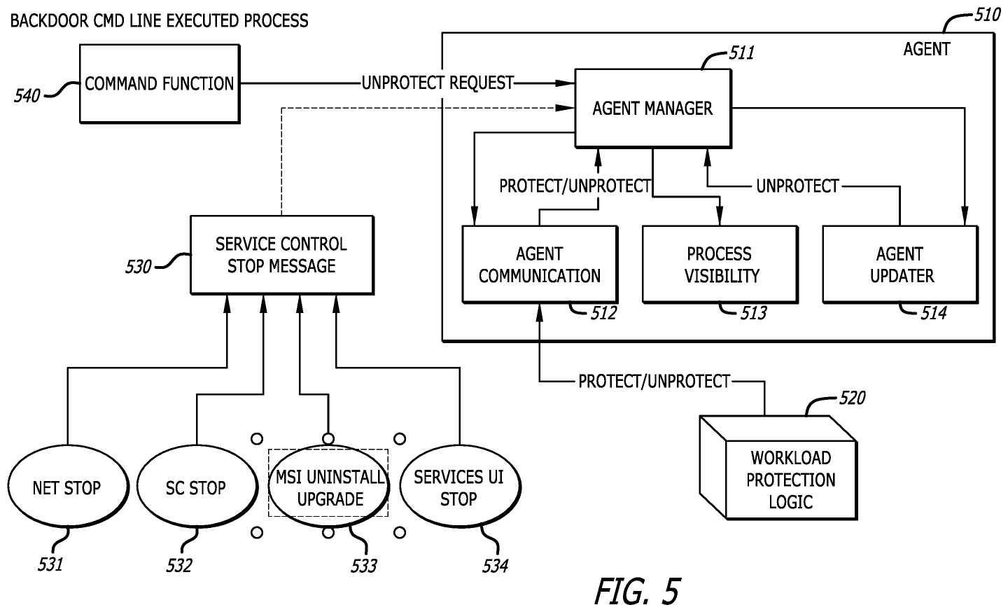

Referring to FIG. 5, a conceptual illustration of an agent 510 operating within an environment in accordance with various embodiments of the disclosure is shown. In various embodiments, the 510 can be deployed to various workloads. In the embodiment depicted in FIG. 5, the agent may comprise an agent manager 511, an agent communication 512, a process visibility 513, and an agent updater 514. The agent manager may be in communication with an operating system and receive various service control stop messages 530. These service control stop messages 530 can be comprise or come from a net stop 531, an SC stop, an MSI uninstall upgrade 533, and a services UI stop 534. As those skilled in the art will recognize, “stop” signals can come from a variety of sources.

The agent 510 may also be in communication with a workload protection logic 520 and may also be configured in certain embodiments to receive a command function 540 from a command line execution process (shown as “backdoor cmd line executed process”). As described in more detail below, the workload protection logic 520 can be in communication with the agent communication 512 and can transmit signals related to enable, disable, or update service protection configurations. Similarly, command line processes can be configured to send signals to the agent 510, which can be commands to disable service protection configurations (shown as “unprotect request”).

As described above, the use of a TOTP may allow for secure communication between the agent 510 and the workload protection logic 520, while also allowing secure disabling through the command function 540. Additionally, not shown is that an agent 510 may also be in communication with the host operating system. These signals may also be processed through the agent communication 512. Finally, the agent updater 514 may able to direct a disabling of the service protection configuration based on the need to update itself, etc.

Although a specific embodiment for an agent 510 operating within an environment suitable for carrying out the various steps, processes, methods, and operations described herein is discussed with respect to FIG. 5, any of a variety of systems and/or processes may be utilized in accordance with embodiments of the disclosure. For example, the number of components, the direction of communication, and/or the messages sent may vary based on the specific deployment and/or configuration. The elements depicted in FIG. 5 may also be interchangeable with other elements of FIGS. 1-4 and 6-11 as required to realize a particularly desired embodiment.

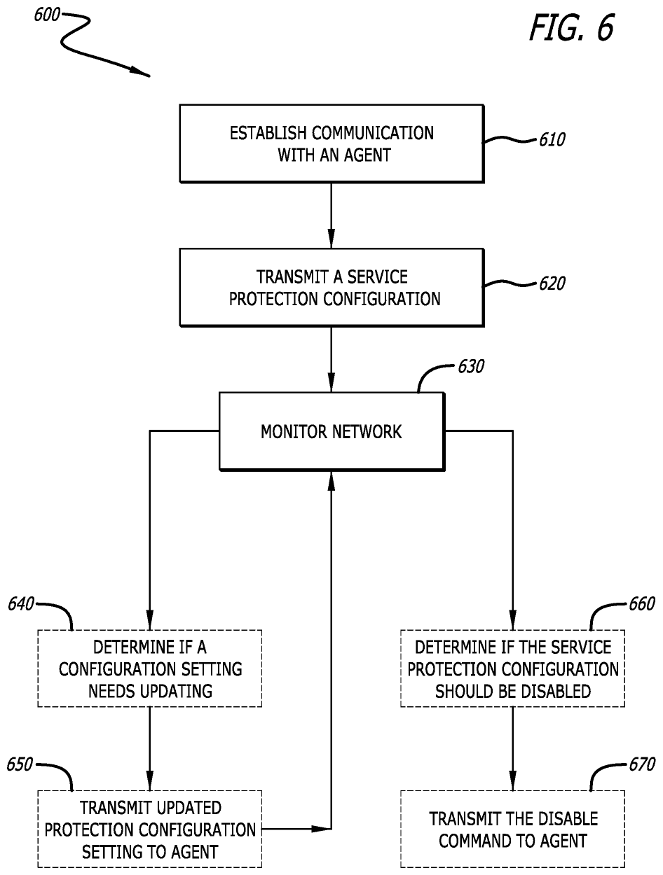

Referring to FIG. 6, a flowchart depicting a process 600 for engaging a service protection configuration with an agent in accordance with various embodiments of the disclosure. In many embodiments, the process 600 can establish communication with an agent (block 610). In certain embodiments, the process 600 can communicate with a plurality of agents across various network devices and processes. This communication can be done remotely through a centralized device operating a workload protection logic, or may be provided through a cloud-based service.

In a number of embodiments, the process 600 can transmit a service protection configuration (block 620). This service protection configuration can be sent to one or more agents. These agents, upon receiving this service protection configuration, can take a number of steps to ensure that they are not shut down inadvertently and/or maliciously by outside service requests.

In more embodiments, the process 600 can monitor the network (block 630). Monitoring the network may be part of the larger workload protection process and can be a security-related exercise or may be configured to monitor the activities of the plurality of agents. In response to one or more events occurring on the network, the process 600 may take various steps that can affect the plurality of agents in communication with the workload protection logic.

In some optional embodiments, the process 600 may determine if a configuration setting needs updating (block 640). This configuration updating may be necessary for one or more agents. For example, a monitored application, workload, operating system, network device, etc. may have been updated and one or more configurations are necessary to keep the agent current. In these embodiments, an updated protection configuration may be generated.

In response to the configuration setting needing updated, further optional embodiments of the process 600 may transmit the updated protection configuration setting to an agent (block 650). As previously discussed, there may be multiple agents that require updating. This updating process may be done serially or in parallel as resources allow. Upon transmitting the update, the process 600 may continue to monitor the network (block 630).

In additional embodiments, the process 600 can optionally determine if the service protection configuration should be disabled (block 660). This may be required when the full service protection is not required, and/or a security threat has dissipated, etc. When it is determined that a service protection configuration should be disabled, then a disable command may be generated.

In more optional embodiments, the process 600 can transmit the disable command to the agent. As described in more detail below, the agent(s) may be configured to not accept any disable commands unless they come from the process 600. The transmission of the disable command may be sent directly to the affected agents, or may be broadcast out for the agents to retrieve and then parse, etc.

Although a specific embodiment for a process 600 for engaging a service protection configuration with an agent suitable for carrying out the various steps, processes, methods, and operations described herein is discussed with respect to FIG. 6, any of a variety of systems and/or processes may be utilized in accordance with embodiments of the disclosure. For example, in some embodiments, the workload protection logic and agents may be on the same network device and therefore may not require transmission of any updated protection configuration and/or disable command. The elements depicted in FIG. 6 may also be interchangeable with other elements of FIGS. 1-5 and 7-11 as required to realize a particularly desired embodiment.

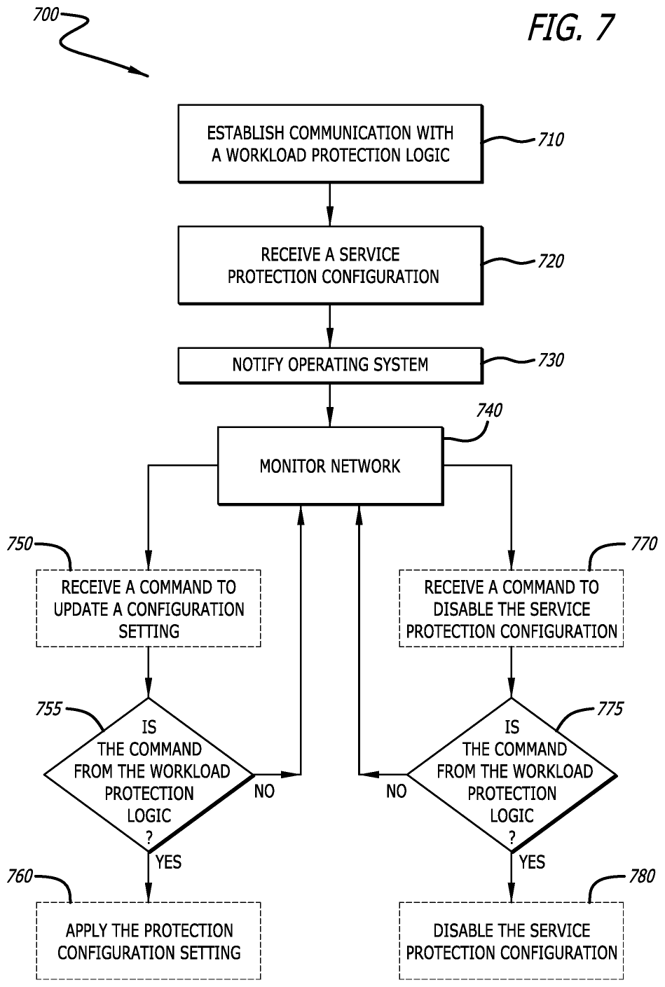

Referring to FIG. 7, a flowchart depicting a process 700 for managing an agent with a received service protection configuration in accordance with various embodiments of the disclosure is shown. In many embodiments, the process 700 can establish communication with a workload protection logic (block 710). The process 700 may be one or many agents communicating with the protection logic. The communication may be a direct back and forth messaging system or can be a broadcast, reception system with intermittent signal distribution as needed.

In a number of embodiments, the process 700 can receive a service protection configuration (block 720). As described above, the service protection configuration can indicate to the agent that no further commands should be accepted unless they come from the source workload protection logic, etc. In some embodiments, this may be limited to specific service requests that are ignored. The exact configuration of the service protection configuration can vary depending on the application desired.

In more embodiments, the process 700 can notify the operating system (block 730). In response to receiving a service protection configuration, the process 700 can generate and transmit a message to the host operating system that no further service requests, commands, etc. will be accepted or otherwise acted on. In some embodiments, the message may be limited to notifying the operating system that the “service stop” signal or the like will be ignored, or otherwise rejected.

In additional embodiments, the process 700 can monitor the network (block 740). This monitoring can be of the general network, but may be associated with a specific process, application, or the like. Monitoring can be done continuously, periodically through a predetermined interval, or in response to certain events.

In some optional embodiments, the process 700 may receive a command to update a configuration setting (block 750). This configuration updating may be necessary for one or more agents. For example, a monitored application, workload, operating system, network device, etc. may have been updated and one or more configurations are necessary to keep the agent current. In these embodiments, an updated protection configuration may be received.

In further embodiments, the process 700 can determine if the command is from the workload protection logic (block 755). As those skilled in the art will recognize, this determination can be accomplished in a variety of ways, including, but not limited to, flags, message source identifiers, password, phrase, or key present in the command, etc. When the command is not from the workload protection logic, various embodiments of the process 700 can continue to monitor the network (block 740).

However, when the received command is from the workload protection logic, the process 700 can optionally apply the protection configuration setting (block 760). This application may still allow the agent to continue to operate while ignoring various commands, stop service signals, and the like. In some embodiments, the agent may subsequently continue to monitor the network, application, etc.

In more optional embodiments, the process 700 may receive a command to disable the service protection configuration (block 770). This may be required when the full service protection is not required, and/or a security threat has dissipated, etc. When it is determined that a service protection configuration should be disabled, then a disable command may be received.

In yet more embodiments, the process 700 can determine if the command is from the workload protection logic (block 775). As those skilled in the art will recognize, this determination can be accomplished in a variety of ways, including, but not limited to, flags, message source identifiers, password, phrase, or key present in the command, etc. When the command is not from the workload protection logic, various embodiments of the process 700 can continue to monitor the network (block 740).

However, when the command is determined to be from the workload protection logic, the process 700 can, in several embodiments, disable the service protection configuration (block 780). In some embodiments, the process 700 may notify the operating system again that it may now accept certain commands, service requests, stop signals, etc. In certain embodiments, the disabling of the service protection configuration may be limited to a certain amount of time before it is re-enabled without additional intervention.

Although a specific embodiment for a process 700 for managing an agent with a received service protection configuration suitable for carrying out the various steps, processes, methods, and operations described herein is discussed with respect to FIG. 7, any of a variety of systems and/or processes may be utilized in accordance with embodiments of the disclosure. For example, in some embodiments, the process 700 may receive commands form a command line execution process which may also be accepted and implemented, depending on the specific deployment and application desired. The elements depicted in FIG. 7 may also be interchangeable with other elements of FIGS. 1-6 and 8-11 as required to realize a particularly desired embodiment.

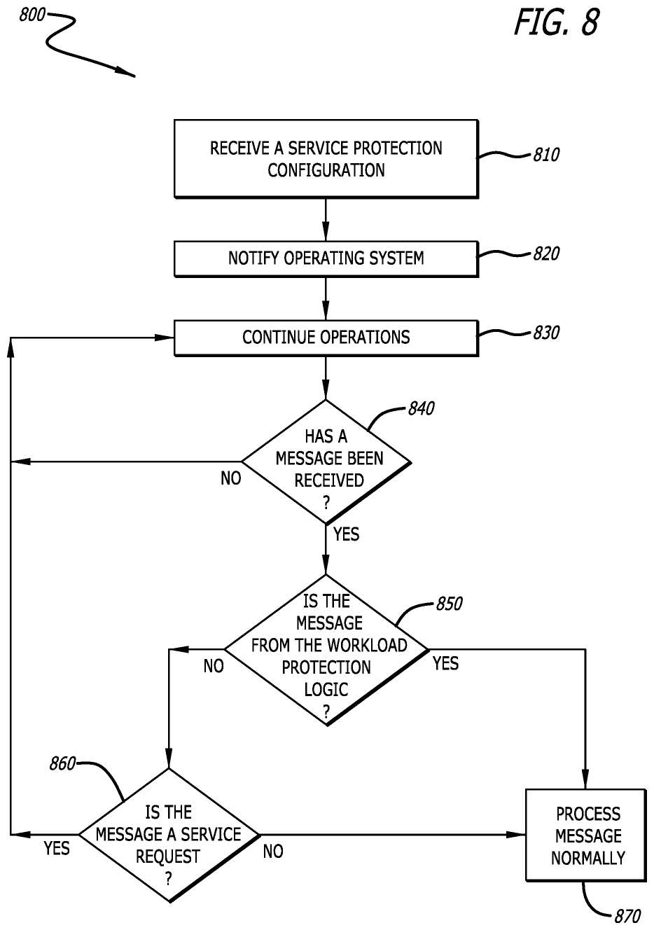

Referring to FIG. 8, a flowchart depicting a process 800 for managing an agent with a received service request in accordance with various embodiments of the disclosure is shown. In many embodiments, the process 800 may receive a service protection configuration (block 810). As described above, the service protection configuration can indicate to the agent that no further commands should be accepted unless they come from the source workload protection logic, etc. In some embodiments, this may be limited to specific service requests that are ignored. The exact configuration of the service protection configuration can vary depending on the application desired.

In a number of embodiments, the process 800 can notify the operating system (block 820). In response to receiving a service protection configuration, the process 800 can generate and transmit a message to the host operating system that no further service requests, commands, etc. will be accepted or otherwise acted on. In some embodiments, the message may be limited to notifying the operating system that the “service stop” signal or the like will be ignored, or otherwise rejected.

In more embodiments, the process 800 can continue operations (block 830). This may include monitoring the network, application, segment, etc. for various threats, security risks, or the like. Those skilled in the art will recognize that an agent can be configured for a variety of tasks and may not be limited to just security-related telemetry tasks, etc.

In various embodiments, the process 800 can determine if a message has been received (block 840). If no message has been received, then the process 800 may again continue operations (block 830). However, if a message has been received, the process 800 can further determine if the received message is from the workload protection logic (block 850). As those skilled in the art will recognize, this determination can be accomplished in a variety of ways, including, but not limited to, flags, message source identifiers, password, phrase, or key present in the command, etc. In response to the message being sourced from the workload protection logic, the process 800 can process the message normally (block 870).

However, when the process 800 determines that the message is not from the workload protection logic, then the process 800 may further determine if the message is a service request (block 860). This may be relevant in certain embodiments where the process 800 or other agents have been configured to ignore service requests. However, when the message is not a service request, the process 800 can process the message normally (block 870). When it is determined that the message is a service request, the process 800 can ignore the message and simply continue operations (block 830).

Although a specific embodiment for a process 800 for managing an agent with a received service request suitable for carrying out the various steps, processes, methods, and operations described herein is discussed with respect to FIG. 8, any of a variety of systems and/or processes may be utilized in accordance with embodiments of the disclosure. For example, the message may be received from a command line execution process which may allow for processing of the message normally as well. The elements depicted in FIG. 8 may also be interchangeable with other elements of FIGS. 1-7 and 9-11 as required to realize a particularly desired embodiment.

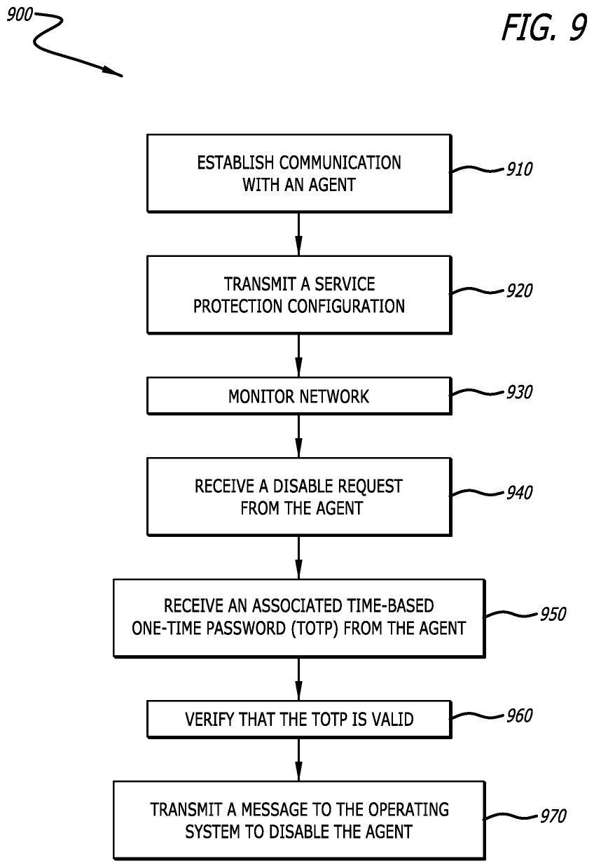

Referring to FIG. 9, a flowchart depicting a process 900 for engaging a service protection configuration with an agent capable of utilizing a time-based one-time password in accordance with various embodiments of the disclosure is shown. In many embodiments, the process 900 can establish communication with an agent (block 910). In certain embodiments, the process 900 can communicate with a plurality of agents across various network devices and processes. This communication can be done remotely through a centralized device operating a workload protection logic, a command line execution process, or may be provided through a cloud-based service or the like.

In a number of embodiments, the process 900 can transmit a service protection configuration (block 920). This service protection configuration can be sent to one or more agents. These agents, upon receiving this service protection configuration, can take a number of steps to ensure that they are not shut down inadvertently and/or maliciously by outside service requests.

In more embodiments, the process 900 can monitor the network (block 930). Monitoring the network may be part of the larger workload protection process and can be a security-related exercise or may be configured to monitor the activities of the plurality of agents. In response to one or more events occurring on the network, the process 900 may take various steps that can affect the plurality of agents in communication with the workload protection logic.

In various embodiments, the process 900 can receive a disable request from the agent (block 940). In these embodiments, the request may be in response to one or more events, or other determinations. In some embodiments, the process 900 will also receive an associated time-based one-time password (TOTP) from the agent (block 950). In certain embodiments, the receiving of the disable request may be paired with the TOTP. In additional embodiments, the TOTP may be embedded or otherwise incorporated into the disable request.

In further embodiments, the process 900 can verify that the TOTP is valid (block 960). As those skilled in the art will recognize, there are numerous methods to verify a TOTP depending on the specific type of TOTP or the application utilized. The presence of a validated TOTP can be utilized to indicate that the received disable request from the agent is genuine and hasn't been maliciously sent from a bad actor or process.

In several embodiments, the process 900 can transmit a message to the operating system to disable the agent (block 970). In some embodiments, the operating system can direct the agent to start accepting various commands, service requests, stop requests, etc. instead of disabling the agent altogether. In further embodiments, the message may be transmitted directly to the agent for processing.

Although a specific embodiment for a process 900 for engaging a service protection configuration with an agent capable of utilizing a time-based one-time password suitable for carrying out the various steps, processes, methods, and operations described herein is discussed with respect to FIG. 9, any of a variety of systems and/or processes may be utilized in accordance with embodiments of the disclosure. For example, in some embodiments, the disable request may be generated from the workload protection logic and sent to the agent with a TOTP that can be verified by the agent prior to disabling, adjusting configurations, etc. The elements depicted in FIG. 9 may also be interchangeable with other elements of FIGS. 1-8 and 10-11 as required to realize a particularly desired embodiment.

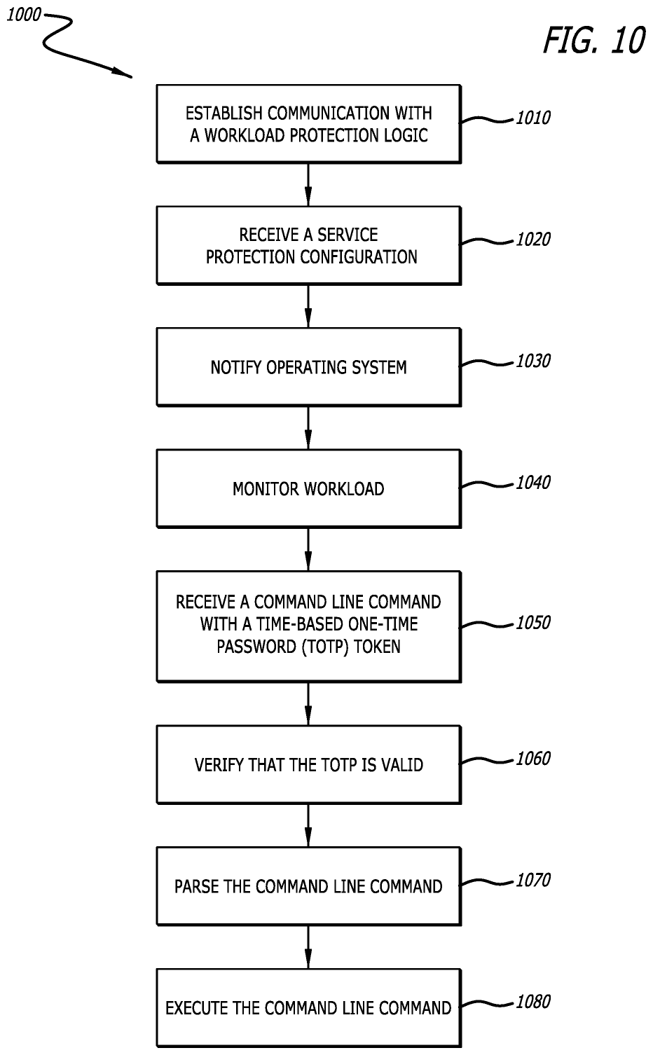

Referring to FIG. 10, a flowchart depicting a process 1000 for managing an agent with a received service protection configuration capable of utilizing a time-based one-time password in accordance with various embodiments of the disclosure is shown. In many embodiments, the process 1000 can establish communication with a workload protection logic (block 1010). The process 1000 may be one or many agents communicating with the protection logic. The communication may be a direct back and forth messaging system or can be a broadcast, reception system with intermittent signal distribution as needed.

In a number of embodiments, the process 1000 can receive a service protection configuration (block 1020). Again, as described above, the service protection configuration can indicate to the agent that no further commands should be accepted unless they come from the source workload protection logic, etc. In certain embodiments, this may be limited to specific service requests (such as “stop” requests) that are ignored. The exact configuration of the service protection configuration can vary depending on the application desired.

In various embodiments, the process 1000 can notify the operating system (block 1030). In response to receiving a service protection configuration, the process 1000 can generate and transmit a message to the host operating system that no further service requests, commands, etc. will be accepted or otherwise acted on. In some embodiments, the message may be limited to notifying the operating system that the “service stop” signal or the like will be ignored, or otherwise rejected. In additional embodiments, the operating system may receive this data via one or more notifications.

In more embodiments, the process 1000 can monitor a workload (block 1040). This monitoring can be of the general network, but may be associated with a specific process, application, or the like. Monitoring can be done continuously, periodically through a predetermined interval, or in response to certain events.

In additional embodiments, the process 1000 can receive a command line command with a time-based one-time password (TOTP) token (block 1050). As previously described, an agent may be configured to receive commands from a command line execution process. As those skilled in the art will recognize, additional data, such as a TOTP, may be added or otherwise incorporated into the command line command. This can be done as a flag, token, or the like.

In several embodiments, the process 1000 can verify that the TOTP is valid (block 1060). As those skilled in the art will recognize, there are numerous methods to verify a TOTP depending on the specific type of TOTP or the application utilized. The presence of a validated TOTP can be utilized to indicate that the received command from the command line execution process is genuine and hasn't been maliciously sent from a bad actor or process.

In still more embodiments, the process 1000 can parse the command line command (block 1070). The received command may be formatted such that the TOTP was included and required removal for verification. The remaining portion of the command may be parsed to determine the command.

In yet additional embodiments, the process 1000 can execute the command line command (block 1080). The command can be an updated protection configuration, or may be a disable command, for example. The command line command may include additional flags that can affect execution such as, but not limited to, timers such that a delay or other time is indicated to execute the command.

Although a specific embodiment for a process 1000 for managing an agent with a received service protection configuration capable of utilizing a time-based one-time password suitable for carrying out the various steps, processes, methods, and operations described herein is discussed with respect to FIG. 10, any of a variety of systems and/or processes may be utilized in accordance with embodiments of the disclosure. For example, in some embodiments, the command may be received from a workload protection logic with an attached or otherwise embedded TOTP within the command or message. The elements depicted in FIG. 10 may also be interchangeable with other elements of FIGS. 1-9 and 11 as required to realize a particularly desired embodiment.

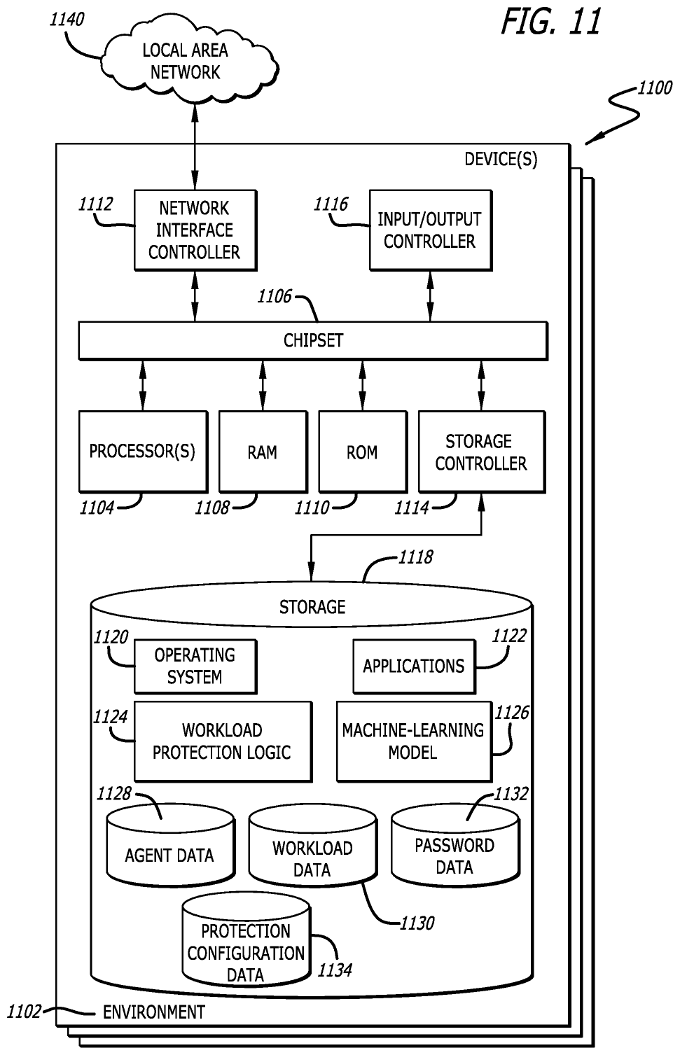

Referring to FIG. 11, a conceptual block diagram of a device 1100 suitable for configuration with a workload protection logic 1124 and/or an agent logic (not shown) in accordance with various embodiments of the disclosure is shown. The embodiment of the conceptual block diagram depicted in FIG. 11 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 1100 may, in some examples, correspond to physical devices and/or to virtual resources and embodiments described herein.

In many embodiments, the device 1100 may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In additional embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1106 may provide an interface between the processor(s) 1104 and the remainder of the components and devices within the environment 1102. The chipset 1106 can provide an interface to communicatively couple a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 and/or transferring information between the various components and devices. The ROM 1110 or NVRAM can also store other application components necessary for the operation of the device 1100 in accordance with various embodiments described herein.

Different embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for example, store an operating system 1120, applications 1122, and data 1128, 1130, 1132, which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

For example, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In various embodiment, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as application 1122 and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-11. In more embodiments, the device 1100 can also include computer-readable storage media having instructions stored thereupon for performing any of the other computer-implemented operations described herein.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

As described above, the device 1100 may support a virtualization layer, such as one or more virtual resources executing on the device 1100. In some examples, the virtualization layer may be supported by a hypervisor that provides one or more virtual machines running on the device 1100 to perform functions described herein. The virtualization layer may generally support a virtual resource that performs at least a portion of the techniques described herein.

In many embodiments, the device 1100 can include a workload protection logic 1124 that can be configured to perform one or more of the various steps, processes, operations, and/or other methods that are described above. While the embodiment shown in FIG. 11 depicts a logic focused on workload protection, it is contemplated that a more general “cybersecurity” logic may be utilized as well or in lieu of such logic. Often, the workload protection logic 1124 can be a set of instructions stored within a non-volatile memory that, when executed by the controller(s)/processor(s) 1104, can carry out these steps, etc. In some embodiments, the workload protection logic 1124 may be a client application that resides on a network-connected device, such as, but not limited to, a server, switch, personal or mobile computing device in a single or distributed arrangement. In certain embodiments, the workload protection logic 1124 can be a dedicated hardware device, cloud-based service, or be configured into a system on a chip package (FPGA, ASIC and the like).

In further embodiments, the storage 1118 may include an agent logic (not shown). As discussed previously, various embodiments may operate as an agent that operates based off of one or more agent logics. In these embodiments, the agent logic can be in communication with a workload protection logic 1124. Similar to the workload protection logic 1124, the agent logic may be a set of instructions stored within a non-volatile memory that, when executed by a controller(s)/processor(s) 1104, can carry out these steps, etc. In some embodiments, the agent logic may be a client application that resides on a network-connected device, such as, but not limited to, a server, switch, personal or mobile computing device in a single or distributed arrangement. In certain embodiments, the agent logic can be a dedicated hardware device, cloud-based service, or be configured into a system on a chip package (FPGA, ASIC and the like) which can be assigned or otherwise associated with a workload.

In a number of embodiments, the storage 1118 can include agent data 1128. As discussed above, the agent data 1128 can be collected in a variety of ways and may involve data related to multiple network devices and agents. The agent data 1128 may be associated with agents deployed across an entire network or on a portion/partition of a network. This may also include a relationship of the various associated workloads that are associated with each other. In additional embodiments, the agent data 1128 can include data related to the configuration of one or more workloads, network devices, data centers, applications, or the like, including, but not limited to, telemetry data, etc. This agent data 1128 can be utilized by a service protection process to generate prompts, suggestions, configurations, or other interactions with an agent when monitoring a network for workload protection. As those skilled in the art will recognize, agent data 1128 can be configured to track a variety of different aspects of a network, it's devices, and associated workloads.

In various embodiments, the storage 1118 can include workload data 1130. As described above, workload data 1130 can be associated with various network devices, data centers, applications, or other processes within a network. Each workload may have additional workload data 1130 associated with it including origin, status, label, scope, etc. In various embodiments, workload data 1130 may be utilized to describe additional attributes of the workload, including one of: a workload's bandwidth usage, latency, traffic patterns, quality-related metrics, throughput, performance, security-related events, resource utilization, and/or scalability traits.

In still more embodiments, the storage 1118 can include password data 1132. As discussed above, password data 1132 can include data that related to an agent's password system, such as a time-based one-time password (TOTP). The password data 1132 may also include any unique aspects needed to validate a TOTP as a token or the like. This may include specific identifiers such as, but not limited to, agent identifier, tenant identifier, or backend public certificate, etc. In certain embodiments, the password data 1132 may include data on how to parse, process, or otherwise handle received TOTP passwords.

In still more embodiments, the storage 1118 can include protection configuration data 1134. As discussed above, protection configuration data 1134 can be transmitted to various agents to secure and prevent unauthorized services from being processed. The protection configuration data 1134 can be combined or utilized in tandem with various other configuration data. In some embodiments, the protection configuration data may be data received from one or more agents deployed on the network. In certain embodiments, the protection configuration data 1134 can be received via one or more web-based protocols which can be stored on a temporary basis or parsed and stored in a long-term way within the protection configuration data 1134.

Finally, in many embodiments, data may be processed into a format usable by a machine-learning model 1126 (e.g., feature vectors, etc.), and or other pre-processing techniques. The machine learning (“ML”) model 1126 may be any type of ML model, such as supervised models, reinforcement models, and/or unsupervised models. The ML model 1126 may include one or more of linear regression models, logistic regression models, decision trees, Naïve Bayes models, neural networks, k-means cluster models, random forest models, and/or other types of ML models 1126. The ML model 1126 may be configured to learn the pattern of a network's current setup and/or any security needs of various network devices and generate predictions, configurations, and/or confidence levels regarding disaster recovery of a network for workload protection and/or segmentation, etc. In some embodiments, the ML model 1126 can be configured to determine which method of generating those predictions would work best based on certain conditions or with certain network devices.

The ML model(s) 1126 can be configured to generate inferences to make predictions or draw conclusions from data. An inference can be considered the output of a process of applying a model to new data. This can occur by learning from at least the telemetry data 1128, workload data 1130, password data 1132, protection configuration data 1134, and/or the underlying algorithmic data and use that learning to predict future configurations, outcomes, and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes. The training set of the ML model(s) 1126 can be provided by the manufacturer prior to deployment and can be based on previously verified data.

Although a specific embodiment for a device 1100 suitable for configuration with a workload protection logic 1124 suitable for carrying out the various steps, processes, methods, and operations described herein is discussed with respect to FIG. 11, any of a variety of systems and/or processes may be utilized in accordance with embodiments of the disclosure. For example, the device may be in a virtual environment such as a cloud-based network administration suite, or it may be distributed across a variety of network devices such that each acts as a device and the workload protection logic 1124 acts in tandem between the devices. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a workload protection logic that is configured to:
establish communication with one or more agents;
apply a service protection configuration to the one or more agents;
determine that an agent of the one or more agents should disable the service protection configuration; and
transmit a disable command to the agent of the one or more agents.

2. The device of claim 1, wherein the workload protection logic is further configured to:
determine if at least one of the one or more agents should have an updated protection configuration; and
transmit an updated protection configuration to the at least one of the one or more agents.

3. A device, comprising:
a processor;
at least one network interface controller configured to provide access to a workload protection logic; and
a memory communicatively coupled to the processor, wherein the memory comprises an agent logic that is configured to:
establish communication with the workload protection logic;
receive a service protection configuration;
enable service protection;
notify an operating system associated with the device of the service protection configuration;
receive a disable command; and
determine if the disable command was received from the workload protection logic.

4. The device of claim 3, wherein the device, in response to the determination that the disable command was received from the workload protection logic, disable the service protection.

5. The device of claim 3, wherein the device, in response to the determination that the disable command was not received from the workload protection logic, ignores disable command.

6. The device of claim 3, wherein the agent logic is further configured to:
receive a configuration update command; and
determine if the configuration update command was received from the workload protection logic.

7. The device of claim 6, wherein the device, in response to the determination that the configuration update command was received from the workload protection logic, update one or more configurations associated with the configuration update command.

8. The device of claim 6, wherein the device, in response to the determination that the configuration update command was not received from the workload protection logic, the configuration update command is ignored.

9. The device of claim 3, wherein the agent logic is configured to receive commands from a backdoor command line execution process.

10. The device of claim 9, wherein the agent logic is further configured to determine if the disable command was received from the backdoor command line execution process.

11. The device of claim 10, wherein the agent logic, in response to the determination that the disable command was received from the backdoor command line execution process, disable the service protection.

12. The device of claim 10, wherein the device, in response to the determination that the disable command was not received from the workload protection logic or the backdoor command line execution process, ignores the disable command.

13. The device of claim 3, wherein the agent logic is further configured to receive a service request.

14. The device of claim 13, wherein a notification to the operating system includes at least a notification that no service requests will be accepted until the service protection configuration is disabled.

15. The device of claim 14, wherein the agent logic is further configured to:
determine if the service protection configuration is enabled; and
in response to the protection configuration being enabled, ignore the service request.

16. A method of operating an agent, comprising:
establishing communication with a workload protection logic;
receiving a service protection configuration;
enabling service protection;
notifying an operating system associated with a device of the service protection configuration;
receiving a command with a time-based one-time password (TOTP);
verify the TOTP is valid; and
executing, in response to the TOTP being verified as valid, the command.

17. The method of claim 16, wherein the command is received from a command line execution process.

18. The method of claim 16, wherein the command is received from a workload protection logic.

19. The method of claim 16, wherein the command is a configuration update command.

20. The method of claim 16, wherein the command is a disable command.
